(19) United States
(12) Patent Application Publication
(10) Pub. No.: US 2023/0150297 A1
(43) Pub. Date: May 18, 2023

(54) INSERT FOR PAINT BUCKETS

(71) Applicant: Chad Van Roekel, Glendale, AZ (US)

(72) Inventor: Chad Van Roekel, Glendale, AZ (US)

(21) Appl. No.: 17/895,880

(22) Filed: Aug. 25, 2022

Related U.S. Application Data
(60) Provisional application No. 63/280,381, filed on Nov. 17, 2021.

(51) Int. Cl. B44D 3/12

(52) U.S. Cl. CPC B44D 3/12; B05B 7/24

(57) ABSTRACT

An insert for paint buckets that is sized and shaped to pool any remaining paint on the bottom of a paint bucket together in one spot for a suction tube or gun or the like to suck up.

### CROSS-REFERENCE TO RELATED APPLICATION

The present application is related to and claims priority from prior provisional application Ser. No. 63/280,381, filed Nov. 17, 2021 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to an insert for paint buckets, and more specifically to inserts for aiding in the removal of paint from a paint bucket.

### 2. Description of the Related Art

Prior art paint buckets are formed having a flat bottom surface making it difficult to remove paint on or near the bottom surface. Paint suction tubes and guns and the like have been used to suck the paint up from the bottom surface of prior art paint buckets, however, these mechanisms cannot get all of the paint up and out and a quantity of paint is always wasted. Thus, a need exists for a paint bucket insert sized and shaped to pool any remaining paint on the bottom of a paint bucket together in one spot for a suction tube or gun or the like to suck up in order to avoid the extra costs of repeatedly wasting paint.

### BRIEF SUMMARY OF THE INVENTION

In view of the foregoing disadvantages inherent in the known types of paint buckets or the like in the prior art, the present invention provides a novel insert for paint buckets. As such, the general purpose of the present invention, which will be described subsequently in greater detail, is to provide a novel insert for paint buckets that is sized and shaped to pool any remaining paint on the bottom of a paint bucket together in one spot for a suction tube or gun or the like to suck up with all the advantages of the prior art and none of the disadvantages.

There has thus been outlined, rather broadly, the more important features of the invention in order that the detailed description thereof that follows may be better understood and in order that the present contribution to the art may be better appreciated. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, An Insert for Paint Buckets, constructed and operative according to the teachings of the present invention.

FIG. 1 shows a perspective view illustrating an insert for a paint bucket according to an embodiment of the present invention.

FIG. 2 shows a perspective view illustrating the insert within a paint bucket according to the embodiment of the present invention in FIG. 1.

FIG. 3 shows a perspective view illustrating a suction tube of a suction gun used in conjunction with the insert within the paint bucket according to the embodiment of the present invention in FIG. 1.

FIG. 4 shows a cross-sectional view of the insert according to the embodiment of the present invention in FIG. 1.

The various embodiments of the present invention will hereinafter be described in conjunction with the appended drawings.

### DETAILED DESCRIPTION

As discussed above, embodiments of the present invention relate to an insert for paint buckets that is sized and shaped to pool any remaining paint on the bottom of a paint bucket together in one spot for a suction tube or gun or the like to suck up.

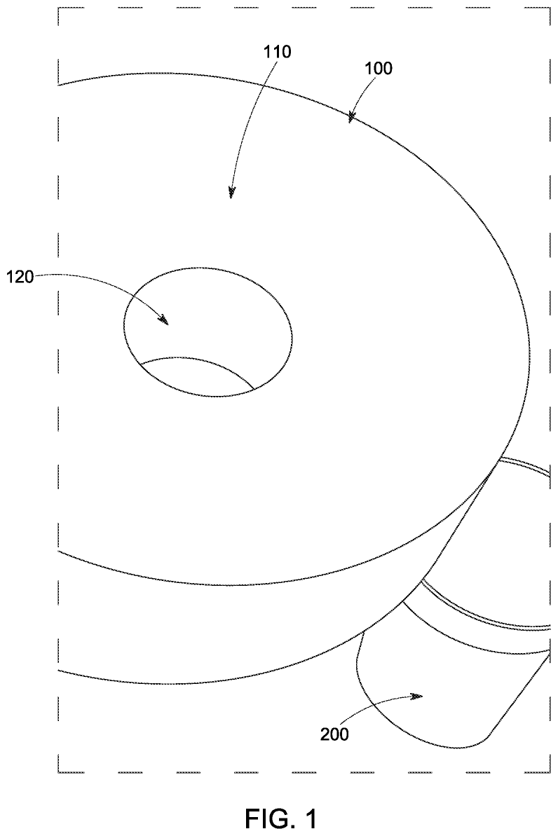

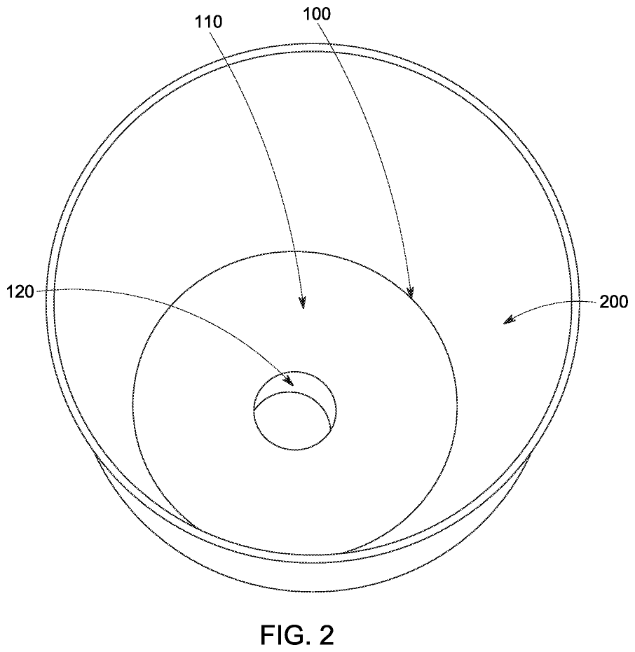

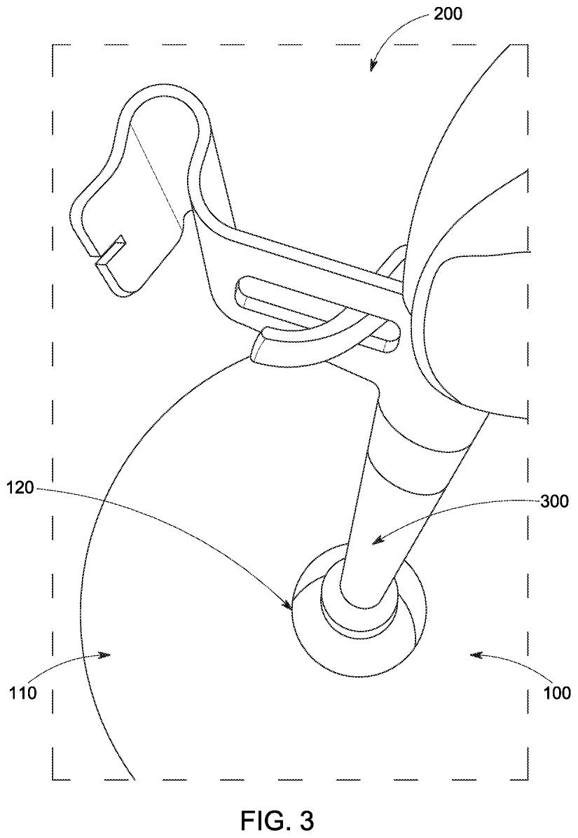

Referring now to FIG. 1-3, the instant invention includes a removable insert 100 for paint buckets 200 comprises a main body having a circular cross-section and, a circular center aperture 120 therethrough. The insert 100 further comprises a bottom surface adapted to be placed upon the inner bottom surface of the paint bucket 200, and a top surface 110 tapered downwardly and inwardly from the outer edge of the insert 100 toward the circular center aperture 120. The circular center aperture 120 may also be tapered from the top portion thereof to the bottom portion thereof forming a funnel shape. As such, the insert 100 is adapted to force all the remaining paint that may be remaining within the paint bucket 200 toward the center of the inner bottom surface thereof for the suction tube of the paint suction gun 300 to access and remove.

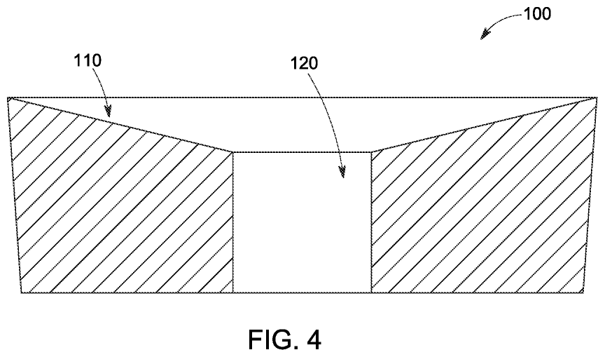

As shown in FIG. 4, the insert 100 has a vertical cross wherein the top surface 110 is tapered downwardly and inwardly from the outer edge of the insert 100 toward the circular center aperture 120. As such, any remaining paint is forced toward and downward into the center aperture 120 for the suction tube of the paint suction gun 300 to access and remove. The angle of the taper, and therefore the angle between top surface 110 and the bottom surface of the insert, can be any angle between 5 degrees and 60 degrees, with the preferred angle being around 30 degrees.

In use, the removable insert 100 is placed upon the inner bottom surface of the paint bucket 200 when the paint supply within the paint bucket is very low in order to be able to suck as much of the paint out of the paint bucket as possible to reduce waste and costs. When the insert is pressed downwardly, the remaining paint is forced either directly into the middle portion of the bottom surface of the paint bucket, or is forced upwardly along the sides of the paint bucket and onto the top surface of the insert to thereby drip inwardly and downwardly along the top tapered surface of the insert and into the circular center aperture 120, and then downwardly to the middle portion of the bottom surface of the paint bucket, such that the suction gun can easily suck the paint out from there. This process can be repeated until all the paint is removed from the paint bucket.

The insert 100 may be formed from a variety of materials, including STYROFOAM (formed from polystyrene foam), plastics, ceramics, and metals. In another embodiment, the insert can be attached to the bottom of a paint bucket via any known attachment means. In another embodiment, the insert can be formed unitarily with the paint bucket via known methods of making including plastic infusion, casting, and 3D printing.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

What is claimed is:

1. An insert for paint buckets comprising:
a main body including:
a top surface;
wherein said top surface includes an outer edge;
a bottom surface;
a side surface
wherein said side surface extends between said top surface and said bottom surface; and
a center aperture;
wherein said center aperture extends through said top surface and said bottom surface; and
wherein said center aperture is sized and shaped to allow a suction tube of a paint suction gun to extend therethrough;
wherein said main body is formed having a circular cross-section and is adapted to fit within a paint bucket and be placed upon an inner bottom surface thereof;
wherein said top surface is tapered downwardly and inwardly from said outer edge toward said center aperture; and
wherein said insert is adapted to force any remaining paint that may be remaining within said paint bucket toward a center portion of said inner bottom surface thereof for said suction tube of said paint suction gun to access and remove.

2. The insert for paint buckets of claim 1, wherein said center aperture has a circular cross-section.

3. The insert for paint buckets of claim 1, wherein said center aperture is tapered from said top surface of said main body to said bottom surface thereof forming a funnel shape.

4. The insert for paint buckets of claim 1, wherein said insert is formed from a material chosen from a list of materials consisting of polystyrene foam, plastic, ceramic, and metal.

5. An improved paint bucket comprising:
a bottom wall;
wherein said bottom wall includes an inner bottom surface; and
a side wall;
wherein said side wall includes an inner side surface; and
wherein said side wall extends upwardly from said bottom wall;
wherein said bottom wall and said side surface form a cylindrical inner volume; and
a removable insert comprising:
a main body including:
a top surface;
wherein said top surface includes an outer edge;
a bottom surface;
a side surface
wherein said side surface extends between said top surface and said bottom surface; and
a center aperture;
wherein said center aperture extends through said top surface and said bottom surface; and
wherein said center aperture is sized and shaped to allow a suction tube of a paint suction gun to extend therethrough;
wherein said main body is formed having a circular cross-section and is adapted to fit within said cylindrical inner volume and be placed upon said inner bottom surface;
wherein said top surface is tapered downwardly and inwardly from said outer edge toward said center aperture; and
wherein said removable insert is adapted to force any remaining paint that may be remaining within said paint bucket toward a center portion of said inner bottom surface thereof for said suction tube of said paint suction gun to access and remove.

6. The improved paint bucket of claim 5, wherein said center aperture has a circular cross-section.

7. The improved paint bucket of claim 5, wherein said center aperture is tapered from said top surface of said main body to said bottom surface thereof forming a funnel shape.

8. The improved paint bucket of claim 5, wherein said removable insert is formed from a material chosen from a list of materials consisting of polystyrene foam, plastic, ceramic, and metal.

9. A combination of a paint suction gun and an improved paint bucket, comprising:
a paint suction gun including:
a suction tube;
wherein said suction tube is sized and shaped to extend into a paint bucket and retrieve paint therefrom;
wherein said paint suction gun is adapted to suck paint out from a paint bucket for use with a paint sprayer; and
an improved paint bucket comprising:
a bottom wall;
wherein said bottom wall includes an inner bottom surface; and
a side wall;
wherein said side wall includes an inner side surface; and
wherein said side wall extends upwardly from said bottom wall;
wherein said bottom wall and said side surface form a cylindrical inner volume; and
a removable insert comprising:
a main body including:
a top surface;
wherein said top surface includes an outer edge;
a bottom surface;
a side surface
wherein said side surface extends between said top surface and said bottom surface; and
a center aperture;
wherein said center aperture extends through said top surface and said bottom surface; and
wherein said center aperture is sized and shaped to allow said suction tube of said paint suction gun to extend therethrough;
wherein said main body is formed having a circular cross-section and is adapted to fit within said cylindrical inner volume and be placed upon said inner bottom surface;
wherein said top surface is tapered downwardly and inwardly from said outer edge toward said center aperture; and
wherein said removable insert is adapted to force any remaining paint that may be remaining within said paint bucket toward a center portion of said inner bottom surface thereof for said suction tube of said paint suction gun to access and remove.

10. The improved paint bucket of claim 9, wherein said center aperture has a circular cross-section.

11. The improved paint bucket of claim 9, wherein said center aperture is tapered from said top surface of said main body to said bottom surface thereof forming a funnel shape.

12. The improved paint bucket of claim 9, wherein said removable insert is formed from a material chosen from a list of materials consisting of polystyrene foam, plastic, ceramic, and metal.
